(19) United States
(12) Patent Application Publication
(10) Pub. No.: US 2025/0316948 A1
(43) Pub. Date: Oct. 9, 2025

(54) Laser Deconfliction Technique

(71) Applicants: James L. Latourell, Jr., Fredericksburg, VA (US); Melissa Ann Olson Phipps, King George, VA (US); Casey P. Stafford, Fredericksburg, VA (US)

(72) Inventors: James L. Latourell, Jr., Fredericksburg, VA (US); Melissa Ann Olson Phipps, King George, VA (US); Casey P. Stafford, Fredericksburg, VA (US)

(73) Assignee: United States of America, as represented by the Secretary of the Navy, Arlington, VA (US)

(21) Appl. No.: 18/626,808

(22) Filed: Apr. 4, 2024

(51) Int. Cl. H01S 3/10

(52) U.S. Cl. CPC H01S 3/10

(57) ABSTRACT

A software framework is provided for a deconfliction safety to aim in a direction and authorize activation of a laser on a platform. The framework includes: a master inhibit module (MIM) interface, a centralized deconfliction process (CDP) module, a decentralized deconfliction process (DDP) module, a user defined region (UDR) module, and a point-&-lasing cutout (PLCO) module. The MIM interface inhibits authorization of the laser activation. The CDP module avoids aiming the laser in the direction that corresponds to a global environmental hazard. The DDP module avoids aiming the laser in the direction that corresponds to a local hazard on the platform. The UDR module for avoiding aiming the laser in the direction that corresponds to a custom limitation hazard. The PLCO module avoids the direction restricted by the environmental, local and custom hazards.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to laser control. In particular, the invention relates to deconfliction safety software for directing and activating a laser.

Previous laser systems relied on a combination of software and hardware to electrically inhibit a laser's firing signal. The software was required to interface directly with many of the laser system's hardware components. The software performed coordinate transformations and safety calculations to arrive at a periodic safe or not safe to fire decision. The safe or not safe to fire decision was sent to a hardware item that passed or interrupted the laser's firing signal.

### SUMMARY

Conventional laser control techniques yield disadvantages addressed by various exemplary embodiments of the present invention. In particular, various exemplary embodiments provide a software framework for a deconfliction safety to aim in a direction and authorize activation of a laser on a platform. The framework includes: a master inhibit module (MIM) interface, a centralized deconfliction process (CDP) module, a decentralized deconfliction process (DDP) module, a user defined region (UDR) module, and a point-&-lasing cutout (PLCO) module.

The MIM interface inhibits authorization of the laser activation. The CDP module avoids firing the laser in the direction that corresponds to a global environmental hazard. The DDP module avoids firing the laser in the direction that corresponds to a local hazard on the platform. The UDR module for avoiding firing the laser in the direction that corresponds to a custom limitation hazard. The PLCO module avoids the direction restricted by the environmental, local and custom hazards.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram view of a laser control system;

FIG. 2 is a block diagram view of the laser control system;

FIG. 3 is a block diagram view of system communication;

FIG. 4 is a block diagram view of hardware of the software and hardware interactions; and

FIG. 5 is a flowchart view of logical operations for laser activation.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

The purpose of the exemplary Deconfliction Safety Software (DSS) Framework is to provide a single application that hosts a variable number of software modules usable by a laser system that enables safe operation of a laser with respect to objects designated within space and/or local firing restrictions. Conventional techniques require two top level configuration items: a computer workstation that interfaces with the laser system hardware and performs safe to fire or not-safe calculations, and a custom hardware module that provides a mechanism to pass or interrupt a laser's firing signal. There are several limitations and disadvantages to this type of a conventional system.

There are several limitations and disadvantages to this type of a conventional system. The two configuration items occupies space and weight in what might otherwise be a lightweight and compact laser system. The system is required to interface directly with laser system's components in order to receive data rather than through the laser system's control software. Because different laser systems use different hardware components, this requires a custom, second hardware item that provided the interface to the hardware. This second hardware item is custom for each laser system.

Conventional software is designed to work with a two-axis mount (azimuth and elevation). Because the software interfaces directly with the laser system's mount, it will not work with a three-axis mount. The software is not modular in the sense that safety capabilities such as range restrictions and platform cutout zones must be part of the software executable even provided they are not required or used.

The hardware configuration item is designed to the requirements of a specific laser system's firing signal in terms of maximum power that can be interrupted. Hence, higher power firing signals cannot use the system. The required hardware configuration items significantly increase the cost of implementation because each laser system that needs the capability is required to purchase the hardware.

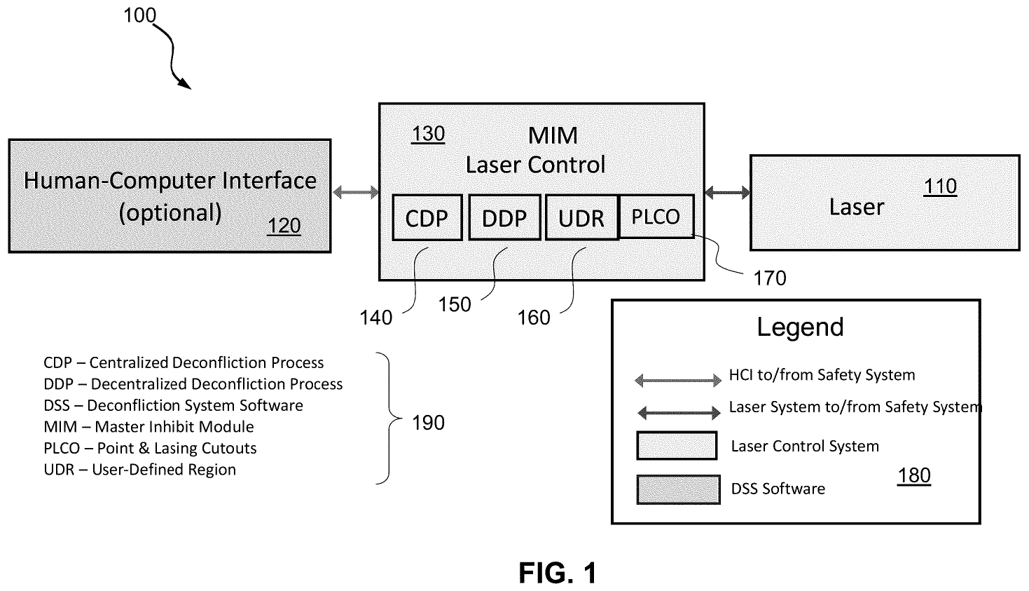

The exemplary Deconfliction Safety Software (DSS) Framework provides a single application and a configurable number of laser safety functions to enable a laser system to operate safely and in accordance with Department of Defense instructions and Test Range restrictions. FIG. 1 is a block diagram view 100 for a laser 110 associated with an optional human computer interface (HCI) 120 of a master inhibit module (MIM) interface for a laser control system 130. The control components include a centralized deconfliction process (CDP) 140, decentralized deconfliction process (DDP) 150, user defined region (UDR) module 160 and point-&-lasing cutout (PLCO) module 170. A legend 180 identifies communication paths, and an abbreviation list 190 identifies the modules.

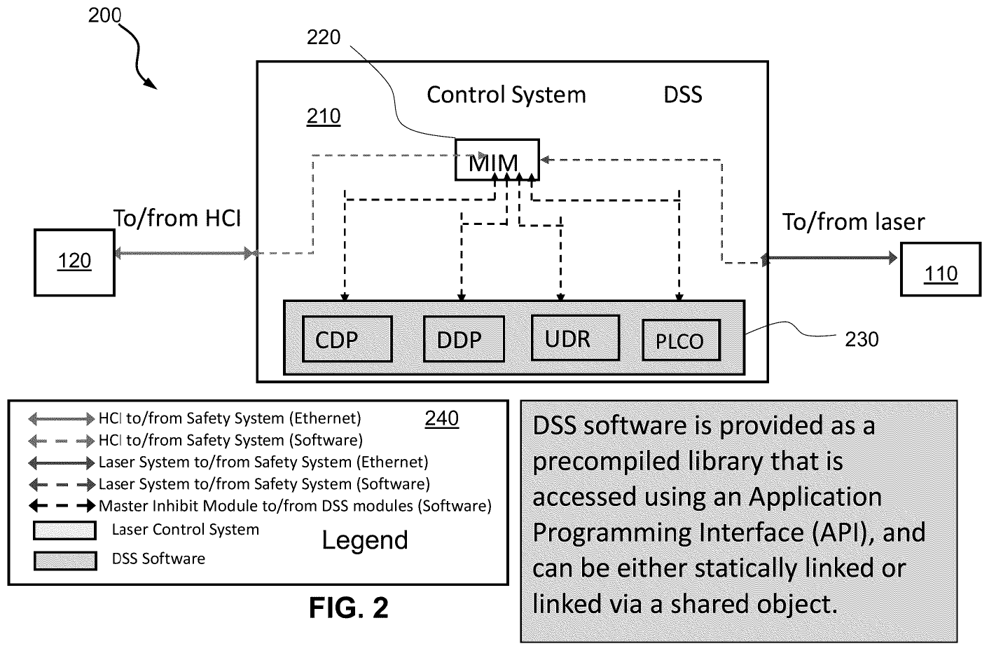

FIG. 2 is a block diagram view 200 for an exemplary laser control system 210. The MIM 220 communicates with the laser 110 and HCI 120, as well as associated with the control interface 130 via ethernet, which communicates with a deconfliction system software (DSS) 230 via software. The DSS 230 includes the CDP 140, DDP 150, UDR 160 and PLCO 170. A legend 240 identifies the communication interfaces.

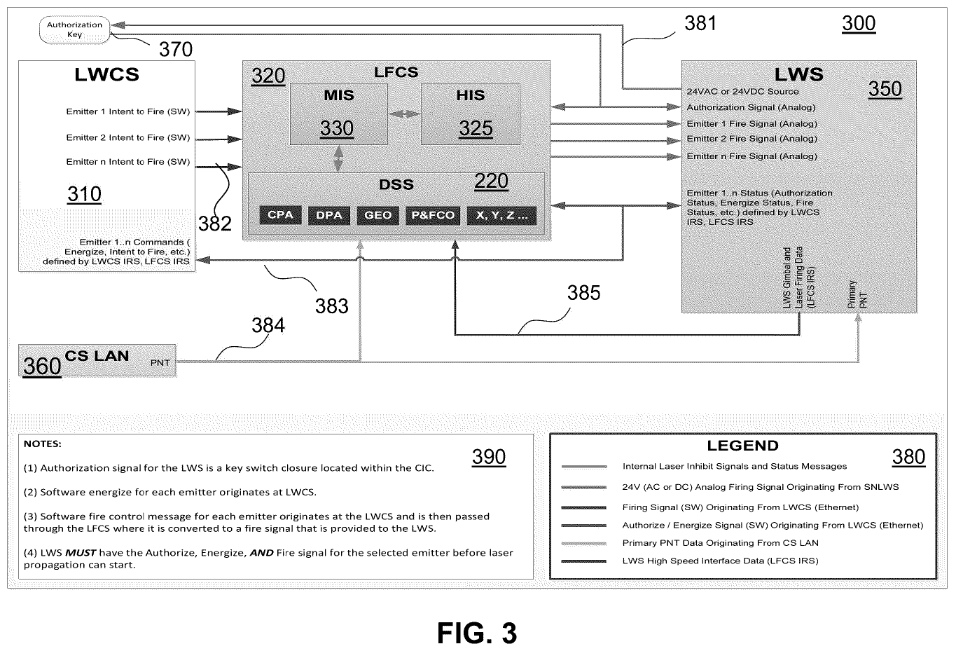

FIG. 3 is a block diagram view 300 for laser control with connecting subsystems. A laser weapon control system (LWCS) 310 communicates with a laser fire control system (LFCS) 320 that includes the DSS 230, HIS 325 and MIS 330. The LWCS 320 also communicates with a laser weapon system (LWS) 350. The LFCS 320 receives signals from the LWS 350 and a CS LAN 360. An authorization key 370 enables the LWS 350 to activate. A legend 380 identifies signal connections, including internal laser inhibition for the DSS 230, analog firing 381 to and from the LWS 350, ethernet firing 382 from the LWCS 310, authorize and energize 383 via ethernet, primary data 384 and LWS data 385, with the information being supplemented by notes 390.

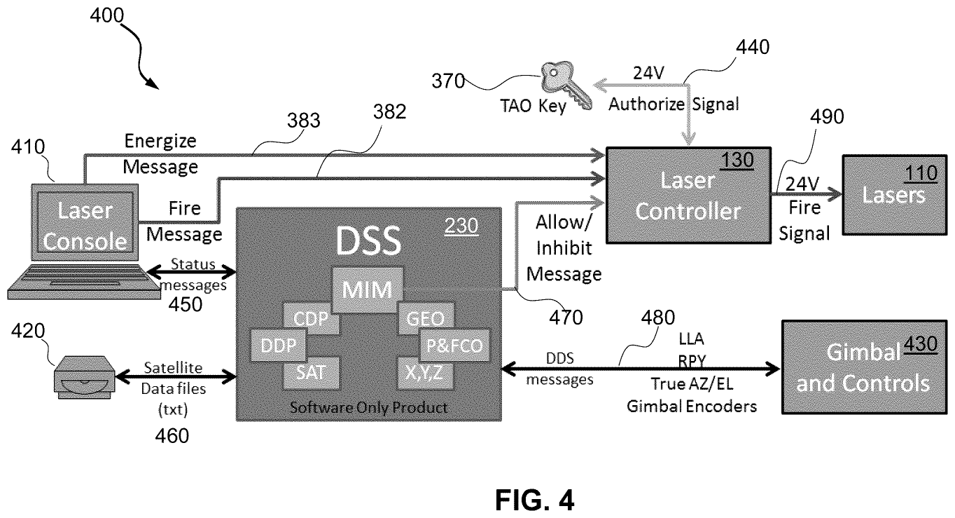

FIG. 4 is a block diagram view 400 for laser control with auxiliary hardware, including a laser console 410 that includes the LWCS 110, satellite text file memory 420, gimbal controls 430, laser 110, DSS 230 and laser controller 130 that receives an authorization signal 440 from the tactical authorization operation key (TAO) key 370. The energize message 383 enables the controller 130 to energize the laser 110, after which the fire message 382 can engage the laser 110 after further protocols are established, including authorization 440 from the key 370.

The DSS 230 exchanges status messages 450 with the console 410 and data files 460 to the memory 420. The MIM 220 within the DSS 230 provides an allow-or-inhibit message 470 to the controller 130. The DSS 230 and gimbal controls 430 exchange messages 480. Upon receipt of a permit message 470 from the MIM 220, the controller 130 issues the fire signal 490 at 24 V.

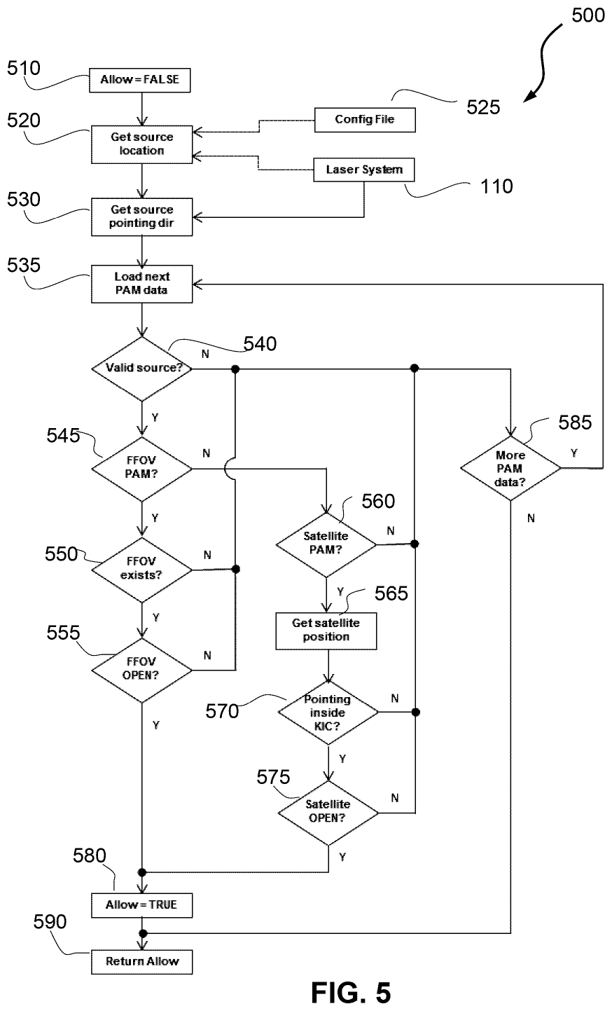

FIG. 5 is a flowchart view 500 of laser fire authorization. The initial default for allow fire is false 510. The process receives source location 520 from the configuration file 525 and the laser system 110. The process receives pointing direction 530 and then loads program approval message (PAM) data 535. The process queries the laser source location validity 540. Satisfaction presents a fixed field of view (FFOV) window PAM query 545. Satisfaction presents an FFOV existence query 550. Satisfaction presents an FFOV open query 555.

Dissatisfaction of the FFOV PAM query 545 diverts to Satellite PAM query 560, for which satisfaction yields receipt of satellite position 565 leading to pointing inside keep-in-cone (KIC) query 570, the satisfaction of which yields satellite open query 575. Satisfaction of either the FFOV or satellite queries 555 or 575 yields an allow fire is true 580. Dissatisfaction of the valid source, FFOV existence or satellite PAM queries 540, 550 or 560 yields more PAM data query 585. Satisfaction returns to the next PAM data 535. Result of true allowance 580 or dissatisfaction of more PAM data 585 concludes with a return allow 590 result.

The exemplary Framework receives real-time data during execution from the laser system 110 to indicate its location on Earth and pointing direction. The Framework combines this with pre-loaded data for satellite protection, laser platform prohibited firing zones, and range safety regions to determine as to whether or not the laser 110 should be permitted to fire. The safe-to-fire determination is made at a 1.0 KHz rate and published via a Data Distribution Service (DDS) message 420 to the laser system 110. The Framework also is capable of receiving messages in accordance with interface document that enables the temporary disabling or enabling of the various safety modules hosted within the Framework. This can be used configure the level of safety provided by the Framework during laser operations.

Because the exemplary Framework is software only, this configuration does not add to the size, weight, and power requirements of a laser system 110. Framework interfaces with a laser's fire control software rather than directly with the laser's fire control hardware. The Framework holds software modules software so that different software modules can be included or removed from a delivery and new modules can be designed and added to the Framework.

This modularity also simplifies the ability to enable or disable capabilities that have been delivered along with the Framework but may not be needed all the time. Because the Framework provides a software message 470 indicating whether or not it is safe to fire, the electrical characteristics of the laser's firing signal do not impact the Framework's design. Because the Framework is merely software, upon the initial purchase of the software, it can be replicated at virtually no cost for an unlimited number of laser systems 110.

There are four existing alternatives to DSS 230: Quick Reaction Capability—Hybrid Predictive Avoidance and Safety System (QRC-HPASS), Technology Maturation—Hybrid Predictive Avoidance and Safety System (TM_HPASS), Joint Laser Deconfliction and Safety System (JLDSS), and Clear2Fire. All four follow the design concept of hardware and software that interfaces directly with laser system hardware and the laser's firing signal 490. They lack the individual capabilities encapsulated in software modules that can be enabled or disabled while the application is running.

The purpose of the software is to provide a modular framework and the software modules that plug into the Framework to achieve the capabilities that satellite deconfliction, user-defined regions (UDRs) 160, and pointing and lasing cutouts (PLCOs) 170. Satellite deconfliction is a methodology that prevents a laser system 110 from unintentionally illuminating a satellite operating in terran orbit. This is typically achieved by hardware, software, or a combination of both that prevents laser energy from exiting a laser system's aperture when the laser 110 is pointed in a direction such that laser energy may illuminate a satellite. UDRs 160 are planar regions, defined in azimuth-elevation space relative to North and local horizontal that are either regions that laser energy must not pass through (prohibited) or regions that laser energy must pass through (required).

This is typically achieved by hardware, software, or a combination of both that prevents laser energy from exiting a laser system's aperture when the laser is pointed in a direction such that laser energy may pass through a Prohibited region or circumstances in which the laser 110 points to a direction such that energy will not pass through a required region. Pointing and lasing cutouts 170 are planar regions, defined in the laser mount system's azimuth-elevation space that are regions that laser energy must not pass through. They are typically used to prevent accidental lasing of the platform carrying the laser system 110.

This is typically achieved by hardware, software, or a combination of both that prevents laser energy from exiting a laser system's aperture when the laser 110 is pointed in a direction such that laser energy may pass through a part of the laser system platform. The DSS 230 is a collection of software modules, each of which provides one of the critical capabilities, e.g., satellite deconfliction, UDRs 160, PLCOs 170.

Each software module in the DSS 230 operates independently of the others and therefore, no particular module is required to be used by a laser system 110 unless it needs the capability the module provides. Each module also implements a function, common to all the modules, that returns whether or not it is safe to fire the laser 110. In a typical application of the DSS software, a laser system 110 would incorporate the DSS software into its control system 130 in such a manner that the common safe-to-fire function is called for each module being used by the control system 130.

Because each module in the DSS 230 operates independently of the others, the individual module calls can be made in parallel or sequentially. When a result has been received from each module, the control system 130 would combine the individual results into an overall result for the laser system 110. It is also possible that depending on the operational state of the laser system 110, the result from a given module may not be used to determine the overall result. Because the modules operate independently, this is easily achieved by either not making the safe-to-fire call on a given module or ignoring the result in response to the call as fire message 382.

The choice of how to implement the logic would be up to the laser control 130. In the case where the DSS software is incorporated into a laser control 130, the data flow into and out of the DSS software would be as follows:
At system startup, the DSS software would be initialized with data files providing satellite orbital data and regions of the sky where satellites may be, a data file indicating where lasing is to be prevented in order to protect the laser system platform, and data files defining any User-Defined Regions. These are static data files in the sense that once they are loaded, the data do not change.
After initialization of DSS 230, the laser system 110 provides real-time laser pointing data at a periodic rate to the laser control system 130. The rate at which a laser system 110 can provide these data are a function of the particular laser system 110 and therefore this rate is contained in a configuration file that the DSS software uses versus having it hard-coded in the software.
For every set of real-time data that the control system 130 receives from the laser system 110, the control system 130 calls the common safe-to-fire function 470 for each of the DSS modules that the control system 130 is using. These calls may be done in parallel or serially.
When all of the function calls have completed, the control system 130 uses those results to make an overall safe-to-fire determination for the laser system 110. The overall determination is then sent from the control system 130 to the laser system 110.

The DSS software also provides situational awareness data that may be displayed on a Human Computer Interface (HCI) 120. These data contain regions of the sky that should not be fired into, pointing and lasing cutout data, and any user-defined regions 160. Real-time fault status of the DSS software is also available for display. The display of any DSS situational awareness or fault status data is optional as it does not directly affect the result of the safe to fire call, which is the purpose of the DSS software. An HCI 120 would also typically be used by the laser system operator to enable and disable DSS software modules as the operational state changes.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A software framework for a deconfliction safety to aim in a direction and authorize activation of a laser on a platform, said framework comprising:
a master inhibit module (MIM) interface for inhibiting authorization of the laser activation;
a centralized deconfliction process (CDP) module for avoiding aiming the laser in the direction that corresponds to a global environmental hazard;
a decentralized deconfliction process (DDP) module for avoiding aiming the laser in the direction that corresponds to a local hazard on the platform;
a user defined region (UDR) module for avoiding aiming the laser in the direction that corresponds to a custom limitation hazard; and
a point-&-lasing cutout (PLCO) module for avoiding the direction restricted by the environmental, local and custom hazards.

2. The frame according to claim 1, wherein the framework communicates with a console to exchange status and provides energizing and fire messages to a controller for the laser.

3. A computer implemented method for authorizing activation as a logical allowance for a laser being aimed in a point direction from a platform location, said method comprising:
setting the allowance to false;
obtaining a first source of the platform location;
obtaining a second source of the point direction;
verifying said first and second sources;
setting the allowance to true; and
enabling the activation of the laser.

4. The method according to claim 3, further including before setting allowance: determining whether FFOV operates.
